(19) United States
(12) Patent Application Publication
(10) Pub. No.: US 2024/0038012 A1
(43) Pub. Date: Feb. 1, 2024

(54) CURBSIDE VOTING CART

(71) Applicant: Gary V. Abel, Ocean City, MD (US)

(72) Inventor: Gary V. Abel, Ocean City, MD (US)

(21) Appl. No.: 18/481,278

(22) Filed: Oct. 5, 2023

Related U.S. Application Data
(63) Continuation of application No. 17/229,937, filed on Apr. 14, 2021.
(60) Provisional application No. 63/413,330, filed on Oct. 5, 2022.
(60) Provisional application No. 63/017,760, filed on Apr. 30, 2020.

(51) Int. Cl. G07C 13/00

(52) U.S. Cl. CPC G07C 13/00; G06Q 2230/00

(57) ABSTRACT

A curbside voter cart for transporting a voting terminal to a parked motorist, comprising a pair of opposing side-rails defined by contiguous tubing, a horizontal long-axle strut spanning the side-rails, a pair of wheels mounted on an axle supported in the long-axle strut, a forwardly-disposed stabilizer spanning the side-rails beneath the axle strut and projecting forward to a horizontal short-axle strut, and a pair of castors mounted on each side of the short-axle strut. In addition, a terminal support platform is adjustably mounted on the side-rails above the wheels and is repositionable anywhere along an upper extent of said side rails for adjustably positioning the voting terminal relative to a voter seated in a car. A voting terminal is supported on the terminal support platform by a pneumatic riser assembly that allows effortless vertical adjustment of the voting terminal to accommodate a range of vehicle types and heights.

### CROSS-REFERENCE TO RELATED APPLICATION(S)

The present application derives priority from U.S. Provisional Patent Application 63/413,330 filed 5 Oct. 2022, and is a continuation of U.S. application Ser. No. 17/229,937 filed 14 Apr. 2021 (which derives priority from U.S. provisional application serial no. 63/017,760 filed Apr. 30, 2020).

### BACKGROUND

### a. Field of invention

The invention relates to curbside voter carts for voting equipment and, more particularly, to a specially-adapted curbside voting cart for transport and deployment of a voting terminal to the driver of a car, thereby creating a single-person voting station without removing the equipment off the cart.

### b. Background of the invention

Due to the infrequent nature of public elections, voting equipment is kept in storage for each voting precinct, normally at a central storage warehouse, and at elections, voter carts are used for transporting the equipment from storage to a public forum, and vice versa after the election. For example, prevalent voting terminals include direct-recording electronic (DRE) voting machines which record votes by means of an electronic ballot display (typically a touchscreen) that records voting data and ballot images onto a removable memory component, and as a printed copy. Alternatively, verified Paper Ballot (VVPB) systems include a touch terminal voting station for generating punched or printed paper ballots, in combination with a ballot box tabulation station for counting the paper ballots. Voters first use the VVPB terminals to generate paper ballots, then move to the ballot box tabulation station and feed in their ballots for counting. VVPB provides an effective paper trail by which to independently audit the election results. Examples of VVPB terminals include the ES&S AutoMARK voter assist terminal (48 lbs and approximately 1.5′×2′×1′), and the ES&S ExpressVote voter assist terminal (20 lbs and approximately 16″×19.8″×13″), although the dimensions of these and other balloting units may change between storage and deployment.

Regardless of the format, most all electronic balloting systems are large, heavy and expensive, and elderly election officials often experience great difficulty in moving, lifting, packing, and transporting the voting equipment. To complicate the issue, many voting jurisdictions are now required by law to provide special curbside voting accommodations to persons 65 years or older, or those with a physical disability that are unable to enter the voting precinct to vote in person. For example, curbside voting is required in North Carolina, South Carolina, Virginia, and some other states. An election official will come to the vehicle to obtain the voter's name and address. The voter must swear an oath affirming his or her qualification to use curbside voting. Then, an election official brings the equipment to the car. Even when not legislatively required, the voters prefer to maintain a degree of social distance. Social distancing limits face-to-face contact otherwise prevalent at voting precincts and helps to decrease the spread of illness among people in community settings. Curbside voting helps in this regard because voters cast their ballot from the confines of their car.

Wherever curbside voting is used, election officials are typically required to simply carry the equipment to the car and hold it steady. However, it is a daunting task to carry the above-mentioned twenty-pound ExpressVote® out to a car and hold it while someone votes. This task could be greatly simplified with a special-purpose cart capable of deploying the voting terminal to the driver in a safe and effective manner.

### SUMMARY OF THE INVENTION

It is, therefore, an object of the present invention to provide a curbside voter cart specifically adapted for touchscreen and VVPN voting terminals that is easily configurable for transporting a variety of election voting terminals as required by various precincts to curbside to allow a disabled voter seated in a car to vote.

It is another object to provide a storage and curbside voter cart that is easily reconfigurable to accommodate a private voting terminal (VVPB, touchscreen or otherwise) and make it accessible from the front of the cart to a driver yet concealed to others including the election official pushing the carts.

It is still another object to provide a curbside voter cart as above that provides robust mechanical restraints to protect against shifting of the equipment, and yet provides full frontal access to the equipment to allow easy off- and on-loading.

It is still another object to provide a curbside voter cart as above that nests with other like carts even with on-board voting terminal for more space-efficient storage.

It is still another object to provide a curbside voter cart as above that maximizes strength and usability, and yet keeps weight to a minimum with a framework that is as light weight as possible, thereby allowing for safe handling of same by polling workers of all ages and physical abilities, even when fully laden with heavy voting equipment.

According to the present invention, the above-described and other objects are accomplished by providing a curbside voter cart for storage, transport and curbside deployment of a single voting terminal to the driver of a car without moving the equipment off the cart, as well as nested storage afterward. The curbside voter cart is capable of securely supporting and protecting a touch-screen or VVPN voting terminal during transport; curbside deployment of the terminal to a useable position for driver voting; and nested storage after use. The cart is generally formed with a pair of opposing upright side-rails formed of contiguous tubing bent in an inverted U-shape. A horizontal long-axle strut traverses the lower ends of the side rails and supports a single-axle wielding large 14″ wheels on opposing sides of the upright side-rails. The curbside voter cart further comprises a forwardly-disposed stabilizer spanning the side-rails beneath the axle strut and projecting forward to a horizontal short-axle strut. Freely-pivoting castors are mounted on each side of the short-axle strut, both forward and inward of the wheels. In addition, the curbside voter cart comprises a forwardly-disposed terminal support platform defined by contiguous tubing bent in a U-shape mounted above the wheels and projecting forward to a protection strut. A horizontal mounting strut is attached across the mounting platform. A pneumatic riser is attached centrally along the mounting strut for supporting a single voting terminal in an upright position. The voting terminal is secured atop the riser for effortless vertical adjustment within a range of from 0″ (flush against the support platform) to 14″ above the support platform. The terminal support platform is removably attached and repositionable anywhere along the length of the upright side-rails, and the horizontal mounting strut is removably attached and repositionable anywhere along the mounting platform for adjustably positioning the voting terminal relative to a voter seated in a car.

### BRIEF DESCRIPTION OF THE DRAWINGS

Additional aspects of the present invention will become evident upon reviewing the embodiments described in the specification and the claims taken in conjunction with the accompanying figures, wherein like numerals designate like elements, and wherein:

FIG. 1 is a perspective view of the curbside voter cart 10 according to an embodiment of the present invention, shown curbside supporting a single voting terminal with shroud removed.

FIG. 2 is an opposite perspective view of the curbside voter cart 10 of FIG. 1 with shroud installed (left) and enlarged inset with shroud 35 removed.

FIG. 3 is a front perspective view of three curbside voter carts 10 of FIGS. 1-2 shown in their nested storage positions.

### DETAILED DESCRIPTION OF THE PREFERRED EMBODIMENT

The present invention is an adaptable curbside voter cart designed for storage and/or transport of multiple and various types of voting machines and accessory components in a convenient, safe and readily accessible manner.

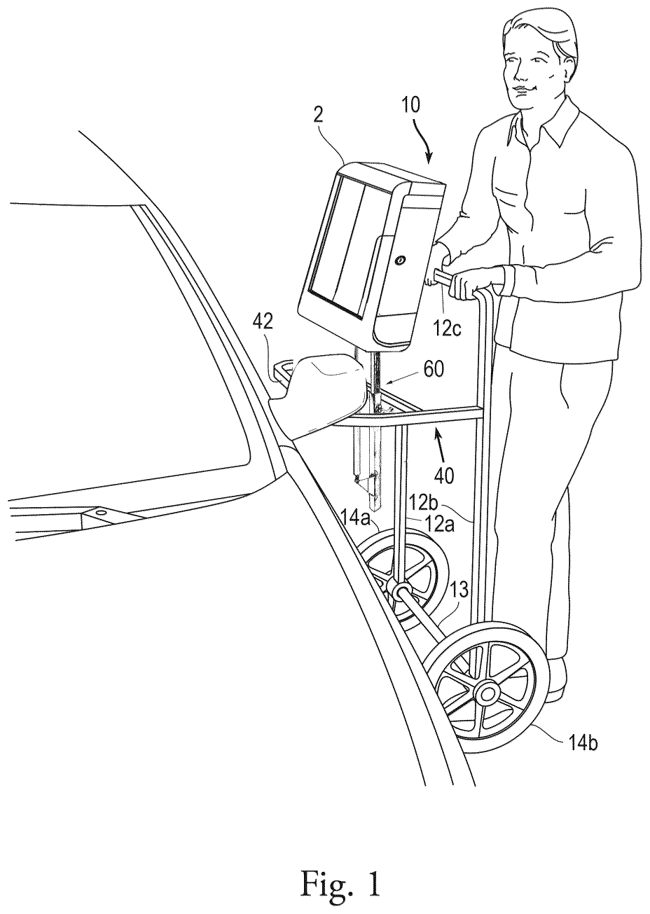

FIG. 1 is a perspective view of a curbside voter cart 10 according to an embodiment of the present invention. The curbside voter cart 10 generally comprises a main frame with a pair of opposing upright side-rails 12a, 12b defined by contiguous tubing bent in an inverted U-shape with a transverse handle 12c at top. Toward the bottom a horizontal long-axle strut 13 traverses the side rails 12a, 12b, both for stability and for supporting a single-axle (internal, obscured). A pair of large 14″ wheels 14a, 14b are mounted on opposing sides of the axle outwardly of the respective side-rails 12a, 12b.

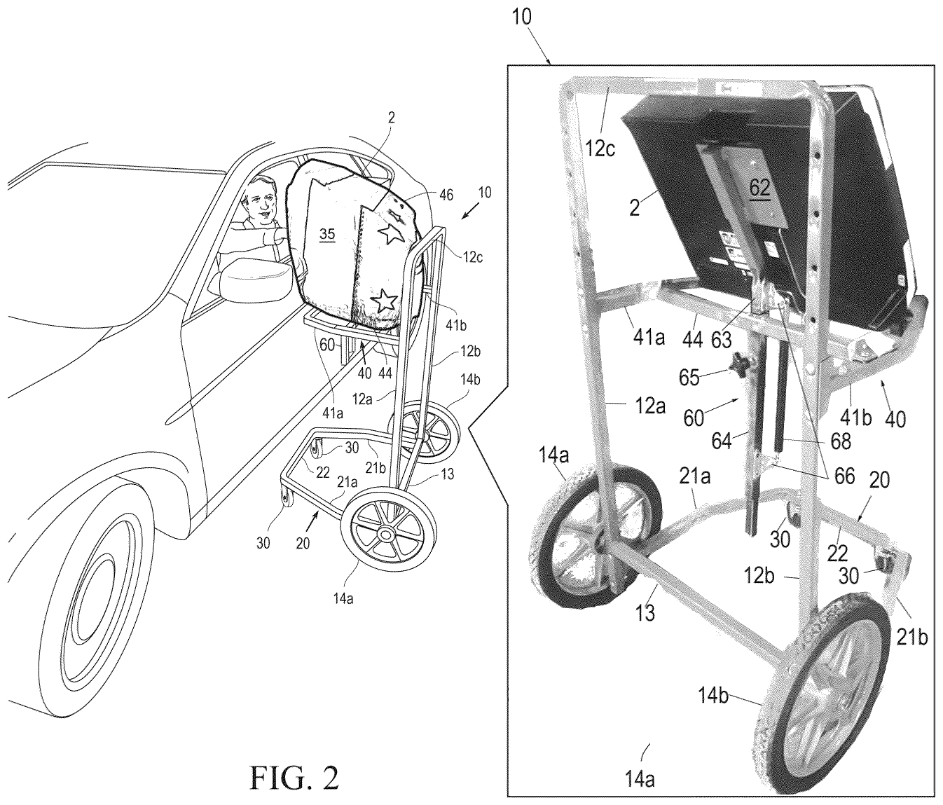

As seen in FIG. 2 the curbside voter cart 10 further comprises a lower stabilizer 20 attached to and projecting forwardly of side-rails 12a, 12b beneath the long-axle strut 13. The lower stabilizer 20 comprises forwardly-projecting side rails 21a, 21b angled inward to converge to a transverse short-axle strut 22. In a preferred embodiment (illustrated) the side rails 21a, 21b of lower stabilizer 20 are attached perpendicularly to respective side-rails 12a, 12b and are obtusely-angled near mid-length to converge forwardly toward short-axle strut 22. However, the side rails 21a, 21b may be arched forwardly to short-axle strut 22, or attached at acute angles to side rails 12a, 12b, and so alternate direct or arched convergences can suffice. Freely-pivoting castors 30 are mounted on opposing sides of the short-axle strut 22, downwardly projecting and positioned both forward and inward of the wheels 14a, 14b. In addition, the curbside voter cart comprises a forwardly-disposed terminal support platform 40 defined by contiguous tubing bent in a U-shape and adjustably mounted to side rails 12a, 12b above the wheels 14a, 14b. Similar to lower stabilizer 20, the terminal support platform 40 has side rails 41a, 41b that converge forward to a protection strut 42. In the preferred embodiment (illustrated) the side rails 41a, 41b of terminal support platform 40 minor those of lower stabilizer 20, are attached perpendicularly to respective side-rails 12a, 12b and are obtusely-angled near mid-length to converge forwardly toward a protection strut 42. Again, however, the side rails 41a, 41b may be arched forwardly to protection strut 42, or attached at acute angles to side rails 12a, 12b, and so alternate direct or arched convergences can suffice. A horizontal mounting strut 44 is attached across the side rails 41a, 41b of terminal support platform 40 for supporting a single voting terminal 2 in an upright position. A pneumatic riser assembly 60 is attached centrally along the mounting strut 44 for effortless vertical adjustment of the voting terminal 2 within a range of from 0″ (flush against the support platform 40) to 14″ above the support platform 40.

As seen in FIG. 2, a fabric or synthetic privacy shroud 35 is removably attached overtop the terminal support platform 40 to provide voting privacy to the voter. The privacy shroud 35 may be a four-sided sewn structure with two side-panels and a top panel. The privacy shroud 35 is wedge-shaped, the top panel being angled downward toward the rear of the voting terminal 2, and the sides being substantially horizontal. The wedge is secured to the side rails 12a, 12b and/or terminal support platform 40 by hook and loop straps or any other means. The privacy shroud 35 hangs evenly down on opposing sides of the voting terminal 2 concealing it and all curbside votes cast with it.

The inset (right) of FIG. 2 shows the curbside voter cart 10 with privacy shroud 35 removed. In the illustrated embodiment as best seen in the inset of FIG. 2, the riser assembly 60 includes an angle bracket 62 secured to the back of the voting terminal 2, the angle bracket 62 having an elongate tubular stem 63 protruding downward. The angle bracket 62 extends upward at about a 20 degree rearward incline for attachment to the voting terminal 2, and lays the terminal 2 back at the same angle for easier viewing from the seat of a vehicle. The angle bracket 62 protrudes downward to an elbow and extends a vertical stem 63 downward. The stem 63 is telescopically received in a sleeve 64 that is affixed centrally along strut 44 and likewise protrudes vertically downward therefrom. A fixation thumbscrew 65 is threaded sidelong into the sleeve 64 and may be tightened against the stem 63 to lock sleeve 64 therein. A pneumatic cylinder 68 is carried between a pair of flanges 66, one flange 66 being attached toward the top of stem 63 and one flange attached toward the bottom of sleeve 64. A suitable pneumatic cylinder 68 is, for example, an 18″ to 32″ adjustable gas lift cylinder with adjustable force in a range of from 50-75 lbs to accommodate various voting terminals. When the thumb screw 65 is loosened the stem 63 is free to slide inside sleeve 64, and the pneumatic cylinder 68 will slowly raise the stem 63, angle bracket 62, and hence the voting terminal 2 to the desired height above support platform 40 within a 14″ range. When the desired height is attained thumb screw 65 is tightened to lock the stem 63 in place inside sleeve 64. To lower the voting terminal 2, the thumbscrew 65 is loosened and the voting terminal 2 is manually pushed down, overcoming the pneumatic cylinder 68 which will slowly lower the stem 63, angle bracket 62, and hence the voting terminal 2 back flush against support platform 40. The pneumatic riser assembly 60 is of great utility in accommodating different vehicle formats quickly, such as sedan, sport utility, minivan, and truck. One skilled in the art should understand that modifications and refinements are possible without departing from the scope or spirit of the invention. For example, the pneumatic cylinder 68 may be incorporated inside the sleeve 64, and indeed the cylinder 68 and sleeve 64 can be combined as a single component and the terminal 2 mounted directly atop the piston of the cylinder 68, albeit this increases manufacturing complexity.

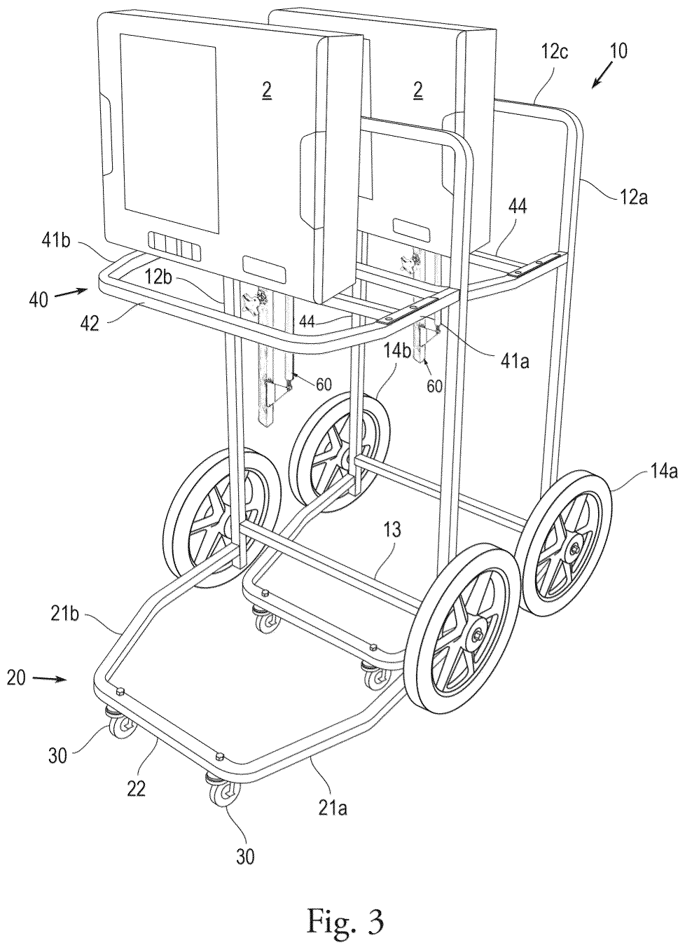

Note in FIG. 3 how the voting terminal 2 remains protected, nested inside the terminal support platform 40, fronted by protection strut 42 and backed by the upper extent of handle 12c. Importantly, both the lower stabilizer 20 and the terminal support platform 40 do not fully nest when voting terminals 2 are nested back-to-back, but rather the lower stabilizer 20 and the terminal support platform 40 limit insertion until the angle of side-rails 12a, 12b and 41a, 41b engages. This measured extent of nesting prevents wheels 14a, 14b from contacting each other and causing imbalance, and also prevents voting terminals 2 from contacting each other and causing damage. Thus, when multiple carts are nested end-to-end voting terminals 2 remain spaced by inches and largely protected from outside damage.

Importantly, both the terminal support platform 40 (and riser assembly 60 along with it), and lower stabilizer 20 are removably attached and repositionable along the upright side-rails 12a, 12b. More specifically, the lower stabilizer 20 is removably attached and repositionable anywhere along the lower extent of the upright side-rails 12a, 12b by endwise tongue-and groove flanges that conform to the upright side-rail tubing, protrude on opposing sides of the lower stabilizer 20, and bolt through a lower series of through-holes provided in the upright side-rails 12a, 12b. Similarly, the terminal support platform 42 is removably attached and repositionable (along with cross-strut 44 and riser assembly 60 along with it), anywhere along an upper extent of the upright side-rails 12a, 12b by endwise tongue-and groove flanges that conform to the upright side-rail tubing, protrude on opposing sides of the terminal support platform 42, and bolt through an upper series of through-holes provided in the upright side-rails 12a, 12b. Similarly, the horizontal mounting strut 44 is removably attached and repositionable (along with the riser assembly 60) anywhere along a medial extent of the terminal support platform 42 by endwise tongue-and groove flanges that conform to the terminal support platform 42 tubing, protrude on opposing sides horizontal mounting strut 44, and bolt through a medial series of through-holes provided in the terminal support platform 42. This three-way adjustability ensures proper curbside vertical and horizontal positioning of the voting terminal 2 during use, as well as proper balance. The seat height of a sedan is typically about 18-22″, a minivan 21-27″, and a pickup truck 33-41″. Add another 10-12″ up to the driver-side window. In sum, to facilitate curbside voting election officials must be capable of positioning the height of the voting terminal 2 within a range of from 28″ to 51″. The above-described pneumatic riser assembly 60 accommodates 80% of vehicles with a fast and effortless pneumatic adjustment, and outliers can be accommodated by adjustment of the terminal support platform 40 (and riser assembly 60 along with it), and lower stabilizer 20.

In use, as seen in FIG. 1-2 an election official tips the cart 10 rearward onto wheels 14a, 14b and wheels the equipment curbside to the car. Dropping the cart 10 onto its casters 30 holds it steady at driver height in a safe and effective manner, and suitably protected from damage such as by inadvertent opening of the vehicle door. The election official unlocks thumbscrew 65, positions the terminal 2 to accommodate the driver, locks the thumbscrew 65, and stands back.

When voting is finished the official rolls the cart 10 back into the precinct and can store it nested as seen in FIG. 3, inasmuch as the entire lower stabilizer 20 slides underneath the axle strut 13 and between side rails 12a, 12b until the angle of side-rails 12a, 12b engages.

It should now be apparent that the curbside voter cart 10 described above provides for easy and secure transport of touchscreen and VVPN voting terminals and is easily reconfigurable for various sizes and weights, and curb heights as encountered at various precincts to allow a disabled voter seated in a car to vote. The voting terminal is fully exposed to the driver of a car yet concealed to others including the election official pushing the carts. Moreover, the cart provides robust mechanical restraints to protect the equipment, and nests with other like carts even with on-board voting terminal for more space-efficient storage after use. Multiple carts may be “stacked” horizontally in close proximity to one another in a storage facility or on a truck bed wherein occasional jolts to one of the carts being stored or transported does not cause a large impact to be felt by the equipment on an adjacent or nearby cart. Voters are able to maintain social distance by avoiding crowds otherwise prevalent at voting precincts because their ballot they can cast the ballots from the sanctity of their car.

Having now fully set forth the preferred embodiment and certain modifications of the concept underlying the present invention, various other embodiments as well as certain variations and modifications of the embodiments shown and described will obviously occur to those skilled in the art upon becoming familiar with the concept. For example, rather than making the pair of opposing upright side-rails 12a, 12b and handle 12c of contiguous tubing bent in an inverted U-shape, discrete lengths of struts may be joined together. In addition, tubular struts may be replaced by I-beams or any other suitable non-tubular strut as a matter of design choice. The same is true of forwardly-disposed terminal support platform 40 mounted above the wheels 14a, 14b, and protection strut 42. It is to be understood, therefore, that the invention may be practiced other than as specifically set forth herein. es and heights.

We claim:

1. A curbside voter cart, comprising:
a main frame having a pair of parallel side rails and a handle;
a pair of wheels mounted on an axle traversing said side rails;
a lower stabilizer rail attached between said pair of parallel side rails and projecting forwardly therefrom;
a pair of castors mounted to said lower stabilizer;
an upper mounting platform rail attached between said pair of parallel side rails and projecting forwardly therefrom above said lower stabilizer rail;
a riser assembly comprising,
a sleeve attached to said upper mounting platform,
an upright support configured for supporting a voting terminal and having a stem protruding downward there from and telescopically received in the sleeve, and
a fixation member inserted into said receptacle and engagable with the stem of the upright support bracket for fixing vertical extension thereof.

2. The curbside voter cart of claim 1, wherein the fixation member comprises a thumbscrew threaded into the receptacle.

3. The curbside voter cart of claim 1, wherein the sleeve and stem are telescopically engaged tubes.

4. The curbside voter cart of claim 3, wherein the sleeve and stem both comprise telescopically engaged tubes having square cross-sections.

5. The curbside voter cart of claim 1, further comprising a transverse strut attached across the upper mounting platform rail, the sleeve being attached to the transverse strut.

6. The curbside voter cart of claim 2, wherein said upright support includes an angle bracket configured to be secured to the back of the voting terminal, and an elongate stem protruding therefrom.

7. The curbside voter cart of claim 1, wherein the riser assembly is a pneumatic riser assembly.

8. The curbside voter cart of claim 7, wherein the riser assembly further comprises a pneumatic cylinder.

9. The curbside voter cart of claim 8, wherein the pneumatic cylinder is connected between the receptacle and upright support bracket.

10. The curbside voter cart of claim 8, wherein said pneumatic riser assembly includes a pair of flanges supporting said pneumatic cylinder, one flange being attached to said stem and another flange being attached to said sleeve.

11. The curbside voter cart of claim 8, wherein said pneumatic cylinder is an adjustable gas cylinder within a range of from 50-75 lbs.

12. The curbside voter cart of claim 1, wherein said upper mounting platform rail defines a hexagon.

13. The curbside voter cart of claim 1, wherein said lower stabilizer rail defines a hexagon.

14. The curbside voter cart of claim 1, wherein said upper mounting platform rail is removably attached to the respective side rails.

15. The curbside voter cart of claim 14, wherein said upper mounting platform rail is adjustably attached to the respective main frame side rails for height-adjustment there along.

16. The curbside voter cart of claim 1, wherein said lower stabilizer rail is removably attached to the respective main frame side rails.

17. The curbside voter cart of claim 16, wherein said lower stabilizer rail is adjustably attached to the respective main frame side rails for height-adjustment there along.

18. A curbside voter cart, comprising:
a main frame having a pair of parallel side rails joined at one end by a transverse handle, and joined at another end by an axle strut;
a pair of wheels mounted on opposing ends of said axle strut;
a lower stabilizer rail attached between said pair of parallel side rails and projecting forwardly therefrom;
a pair of castors mounted to said lower stabilizer;
an upper mounting platform rail attached between said pair of parallel side rails and projecting forwardly therefrom above said lower stabilizer rail;
a pneumatic riser assembly comprising,
a sleeve attached to said upper mounting platform,
an upright support configured for supporting a voting terminal and having a stem protruding downward there from and telescopically received in the sleeve, and
a pneumatic cylinder connected between said sleeve and said upright support.

19. The curbside voter cart of claim 18, further comprising a transverse strut attached across the upper mounting platform rail, the sleeve being attached to the transverse strut.

20. The curbside voter cart of claim 18, said pneumatic riser assembly further comprising a fixation member inserted into said receptacle and engageable with the stem of the upright support bracket for fixing vertical extension thereof.
